(19) United States
(12) Patent Application Publication
(10) Pub. No.: US 2025/0310891 A1
(43) Pub. Date: Oct. 2, 2025

(54) METHOD AND USER EQUIPMENT FOR REDUCING POWER CONSUMPTION

(71) Applicant: MEDIATEK INC., Hsinchu City (TW)

(72) Inventors: Ting-Yi Yu, Hsinchu City (TW); Ling-Chun Kuo, Hsinchu City (TW); Yi-Chieh Lee, Hsinchu City (TW); Ching-Wen Hu, Hsinchu City (TW); Che-Yuan Hu, Hsinchu City (TW); I-Jui Chiu, Hsinchu City (TW); Ruei-Bin Yang, Hsinchu City (TW); Yi-Cheng Lai, Hsinchu City (TW); Teemu Olkkola, Oulu (FI); Ville Karsikko, Oulu (FI); Chih-Wen Chiang, Hsinchu City (TW); Chia-Lin Wu, Hsinchu City (TW); Juha Markus Tuomainen, Oulu (FI); Guang-Yu Zheng, Hsinchu City (TW); Lian-Li Tsai, Hsinchu City (TW); Kai-Tai Yang, Hsinchu City (TW)

(73) Assignee: MEDIATEK INC., Hsinchu City (TW)

(21) Appl. No.: 19/083,455

(22) Filed: Mar. 19, 2025

Related U.S. Application Data
(60) Provisional application No. 63/570,312, filed on Mar. 27, 2024.
(60) Provisional application No. 63/759,376, filed on Feb. 17, 2025.

(51) Int. Cl. H04W 52/02; H04W 72/232; H04W 76/28

(52) U.S. Cl. CPC H04W 52/0261; H04W 72/232; H04W 76/28

(57) ABSTRACT

A method for reducing power consumption, for a user equipment (UE) of a wireless communication network includes receiving a message indicating a commencement of a physical downlink control channel (PDCCH) skipping duration from a network node; determining whether or not to enable a simulated discontinuous reception (DRX) inactive state during the PDCCH skipping duration according to at least one predefined condition; and entering the simulated DRX inactive state when the at least one predefined condition is met.

### CROSS REFERENCE TO RELATED APPLICATIONS

This application claims the benefit of U.S. Provisional Application No. 63/570,312, filed on Mar. 27, 2024. Further, this application claims the benefit of U.S. Provisional Application No. 63/759,376, filed on Feb. 17, 2025. The contents of these applications are incorporated herein by reference.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An exemplary telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology.

Therefore, improvements are necessary to the conventional technique.

### SUMMARY

In light of this, the present invention provides a method and a user equipment to reduce monitoring activities and the power consumption of the UE.

An embodiment of the present invention provides a method for reducing power consumption, for a user equipment (UE) of a wireless communication network, comprises receiving a message indicating a commencement of a physical downlink control channel (PDCCH) skipping duration from a network node; determining whether or not to enable a simulated discontinuous reception (DRX) inactive state during the PDCCH skipping duration according to at least one predefined condition; and entering the simulated DRX inactive state when the at least one predefined condition is met.

Another embodiment of the present invention provides a User Equipment (UE) of a wireless communication network, comprises a wireless transceiver, configured to perform wireless transmission and reception to and from a service network; and a controller, configured to receive a message indicating a commencement of a physical downlink control channel (PDCCH) skipping duration from a network node; to determine whether or not to enable a simulated discontinuous reception (DRX) inactive state during the PDCCH skipping duration according to at least one predefined condition; and to enter the simulated DRX inactive state when the at least one predefined condition is met.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication network according to an embodiment of the present invention.

FIG. 2 is a schematic diagram of a user equipment (UE) according to an embodiment of the present invention.

FIG. 3 is a schematic diagram of a method for reducing power consumption according to an embodiment of the present invention.

FIG. 4 is a schematic diagram of a PDCCH skipping scenario according to an embodiment of the present invention.

FIG. 5 is a schematic diagram of the PDCCH skipping scenario according to another embodiment of the present invention.

### DETAILED DESCRIPTION

The following description is made for the purpose of illustrating the general principles of the application and should not be taken in a limiting sense. It should be understood that the embodiments may be realized in software, hardware, firmware, or any combination thereof. The terms “comprises, “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

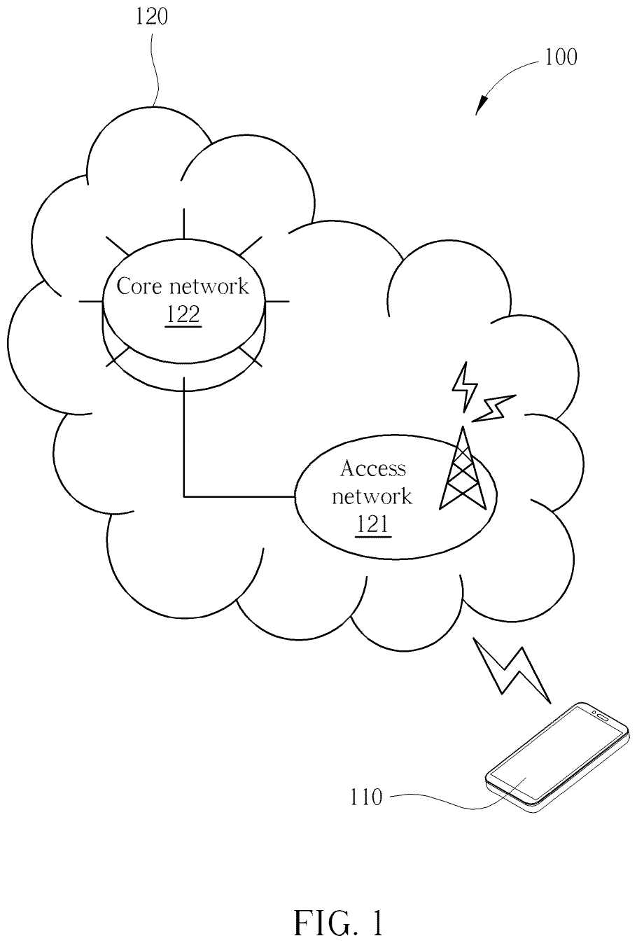

FIG. 1 is a schematic diagram of a wireless communication network 100 according to an embodiment of the present invention.

As shown in FIG. 1, the wireless communication network 100 may include a user equipment (UE) 110 and a service network 120, wherein the UE 110 may be wirelessly connected to the service network 120 for obtaining mobile services and performing cell measurements on the cell(s) of the service network 120.

The UE 110 may be a feature phone, a smartphone, a panel Personal Computer (PC), a laptop computer, or any wireless communication device supporting the wireless technology (e.g., the 5G NR technology) utilized by the service network 120. In another embodiment, the UE 110 may support more than one wireless technology. For example, the UE 110 may support the 5G NR technology and a legacy 4G technology, such as the LTE/LTE-A/TD-LTE technology.

The service network 120 includes an access network 121 and a core network 122. The access network 121 is responsible for processing radio signals, terminating radio protocols, and connecting the UE 110 with the core network 122. The core network 122 is responsible for performing mobility management, network-side authentication, and interfaces with public/external networks (e.g., the Internet). Each of the access network 121 and the core network 122 may comprise one or more network nodes for carrying out said functions.

In one embodiment, the service network 120 may be a 5G NR network, and the access network 121 may be a Radio Access Network (RAN) and the core network 122 may be a Next Generation Core Network (NG-CN).

A RAN may include one or more cellular stations, such as next generation NodeBs (gNBs), which support high frequency bands (e.g., above 24 GHz), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A 5G cellular station may form one or more cells with different Component Carriers (CCs) for providing mobile services to the UE 110. For example, the UE 110 may camp on one or more cells formed by one or more gNBs or TRPs, wherein the cells which the UE 110 is camped on may be referred to as serving cells, including a Primary cell (Pcell) and one or more Secondary cells (Scells).

An NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

In another embodiment, the service network 120 may be an LTE/LTE-A/TD-LTE network, and the access network 121 may be an Evolved-Universal Terrestrial Radio Access Network (E-UTRAN) and the core network 122 may be an Evolved Packet Core (EPC).

An E-UTRAN may include at least one cellular station, such as an evolved NodeB (eNB) (e.g., macro eNB, femto eNB, or pico eNB), each of which may form a cell for providing mobile services to the UE 110. For example, the UE 110 may camp on one or more cells formed by one or more eNBs, wherein the cells which the UE 110 is camped on may be referred to as serving cells, including a Pcell and one or more Scells.

An EPC may include a Home Subscriber Server (HSS), Mobility Management Entity (MME), Serving Gateway (S-GW), and Packet Data Network Gateway (PDN-GW or P-GW).

It should be understood that the wireless communication network 100 described in the embodiment of FIG. 1 is for illustrative purposes only and is not intended to limit the scope of the application. For example, the wireless communication network 100 may include both a 5G NR network and a legacy network (e.g., an LTE/LTE-A/TD-LTE network, or a WCDMA network), and the UE 110 may be wirelessly connected to both the 5G NR network and the legacy network.

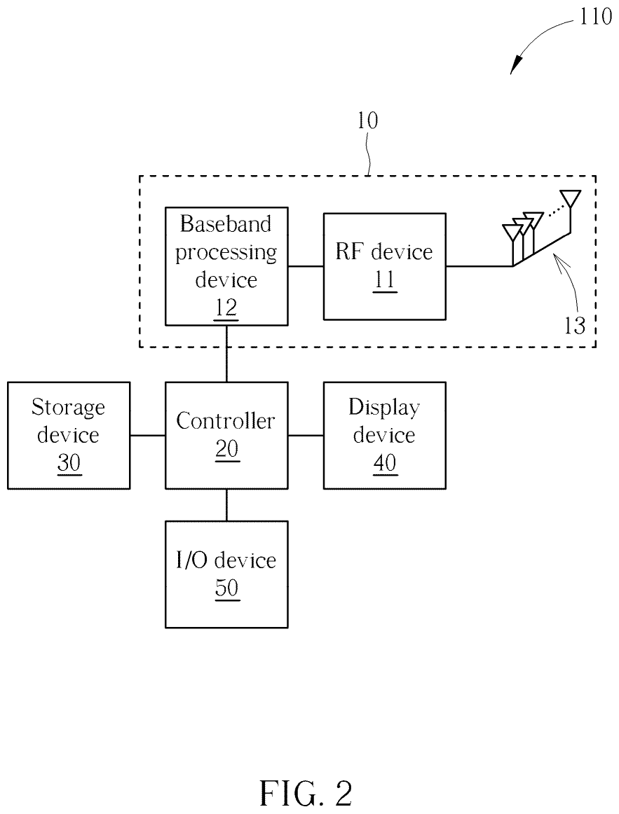

FIG. 2 is a schematic diagram of the UE 110 according to an embodiment of the present invention.

As shown in FIG. 2, the UE 110 may include a wireless transceiver 10, a controller 20, a storage device 30, a display device 40, and an Input/output (I/O) device 50.

The wireless transceiver 10 is configured to perform wireless transmission and reception to and from the cells formed by one or more cellular stations of the access network 121. Specifically, the wireless transceiver 10 may include a Radio Frequency (RF) device 11, a baseband processing device 12, and antenna(s) 13, wherein the antenna(s) 13 may include one or more antennas for beamforming. The baseband processing device 12 is configured to perform baseband signal processing and control the communications between subscriber identity card(s) (not shown) and the RF device 11. The baseband processing device 12 may contain multiple hardware components to perform the baseband signal processing, including Analog-to-Digital Conversion (ADC)/Digital-to-Analog Conversion (DAC), gain adjusting, modulation/demodulation, encoding/decoding, and so on. The RF device 11 may receive RF wireless signals via the antenna(s) 13, convert the received RF wireless signals to baseband signals, which are processed by the baseband processing device 12, or receive baseband signals from the baseband processing device 12 and convert the received baseband signals to RF wireless signals, which are later transmitted via the antenna(s) 13. The RF device 11 may also contain multiple hardware devices to perform radio frequency conversion. For example, the RF device 11 may comprise a mixer to multiply the baseband signals with a carrier oscillated in the radio frequency of the supported cellular technologies, wherein the radio frequency may be any radio frequency (e.g., 30 GHz-300 GHz for mm Wave) utilized in the 5G NR technology, or may be 900 MHz, 2100 MHz, or 2.6 GHz utilized in LTE/LTE-A/TD-LTE technology, or another radio frequency, depending on the wireless technology in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communications with the cells formed by cellular station of the access network 121, storing and retrieving data (e.g., program code) to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 for performing the method for performing a cell measurement.

In another embodiment, the controller 20 may be incorporated into the baseband processing device 12, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data (e.g., measurement configurations, DRX configurations, and/or measurement results), instructions, and/or program code of applications, communication protocols, and/or the method for performing a cell measurement.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MIMI) for interaction with users.

It should be understood that the components described in the embodiment of FIG. 2 are for illustrative purposes only and are not intended to limit the scope of the application. For example, the UE 110 may include more components, such as a power supply, and/or a Global Positioning System (GPS) device, wherein the power supply may be a mobile/replaceable battery providing power to all the other components of the UE 110, and the GPS device may provide the location information of the UE 110 for use by some location-based services or applications. Alternatively, the UE 110 may include fewer components. For example, the UE 110 may not include the display device 40 and/or the I/O device 50.

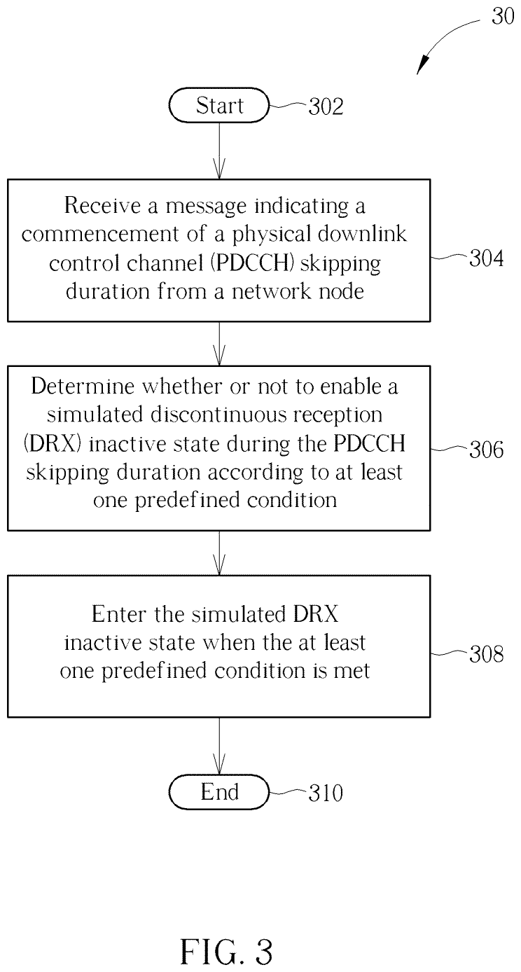

FIG. 3 is a schematic diagram of a method 30 for reducing power consumption according to an embodiment of the present invention. In this embodiment, the method 30 for reducing power consumption is executed by the UE 110 with the wireless transceiver 10. The method for reducing power consumption includes:

Step 302: Start;

Step 304: Receive a message indicating a commencement of a physical downlink control channel (PDCCH) skipping duration from a network node;

Step 306: Determine whether or not to enable a simulated discontinuous reception (DRX) inactive state during the PDCCH skipping duration according to at least one predefined condition;

Step 308: Enter the simulated DRX inactive state when the at least one predefined condition is met;

Step 310: End.

In step 304, the UE 110 receives the message, i.e. downlink control information (DCI), from a network node, e.g., gNBs, wherein the DCI indicates to the UE to skip PDCCH monitoring.

In detail, the gNB dispatches the DCI message to the UE instructing the UE 110 to commence the PDCCH skipping procedure for a specified duration.

In step 306, the UE 110 is configured to determine whether or not to enable the simulated DRX inactive state during the PDCCH skipping duration according to the predefined conditions, wherein the predefined conditions are that the UE is not required to monitor cell radio network identifier (C-RNTI) on Type 3 PDCCH Common Search Space (CSS) or User Specific Search Space (USS).

Since the UE 110 predominantly monitors its C-RNTI Type 3 PDCCH CSS or USS, in step 306 of the method 30, the UE 110 according to an embodiment of the present invention emulates a state akin to DRX when the UE 110 is not required to monitor C-RNTI Type 3 PDCCH CSS or USS. In this way, the power consumption is reduced and thereby the performance is increased.

Therefore, the UE 110 determines whether the DRX inactivity for the duration of the PDCCH skipping could be repurposed or not according to the predefined conditions.

When the predefined conditions are met, i.e., the UE is not required to monitor the C-RNTI Type 3 PDCCH CSS or USS, the UE 110 permits the PDCCH skipping interval in response to the DCI message from the gNB. Then, the UE 110 enters the simulated DRX inactive state in step 308. Further, when the at least one conditions is met, entering the simulated DRX inactive state and terminating the ongoing PDCCH skipping duration in that state.

In another embodiment, the behavior of the UE 110 during the simulated DRX inactive period is the same as the behavior of the UE 110 during the DRX inactive period. During this period, the UE 110 will turn off the receiver and will not receive downlink data and control information to reduce power consumption.

In another embodiment, the UE 110 receives a message from the network related to Search Space Set Group (SSSG) parameters, which include instructions for the UE to perform PDCCH monitoring. The UE will enter the DRX inactive state during a PDCCH monitoring occasion gap between two adjacent PDCCH monitoring occasions, provided that the at least one predefined condition is met. This will further achieve the goal of effectively managing power consumption.

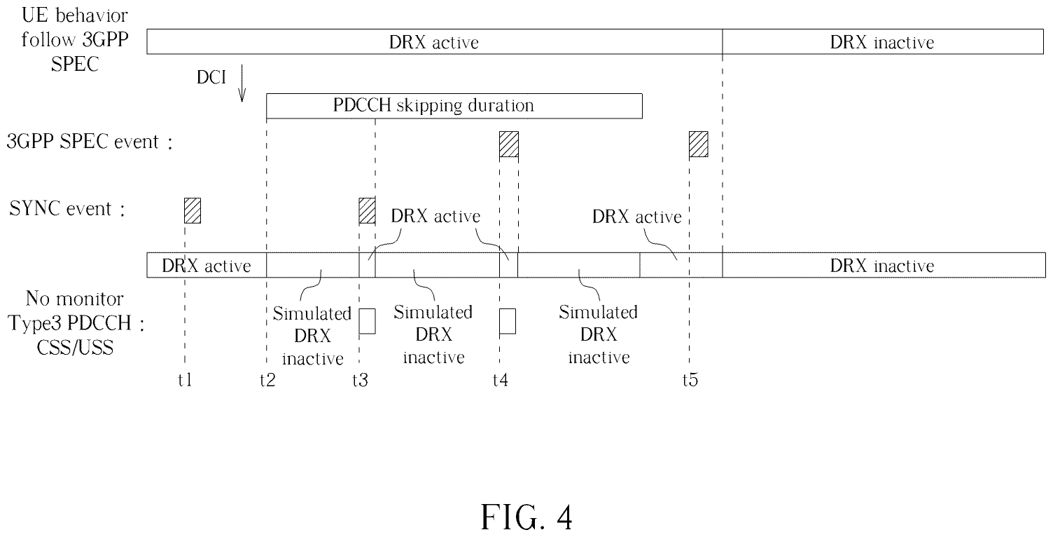

Please refer to FIG. 4, which is a schematic diagram of the PDCCH skipping scenario according to an embodiment of the present invention.

The PDCCH skipping duration during the DRX active is performed after the DCI from the gNB is permitted by the UE 110. As shown in FIG. 4, the PDCCH skipping duration starts at a timing t2. Before the timing PDCCH skipping duration, a synchronization event at a timing t1 happens during the DRX active period.

At a timing t3, another synchronization event happens during the PDCCH skipping duration, and thus the UE 110 goes back to the DRX active state from the simulated DRX inactive state to finish the event.

At a timing t4, the conventional 3GPP specification (SPEC) events, e.g., channel state information (CSI), sounding reference signal (SRS), happen, and the UE 110 goes back to the DRX active state from the simulated DRX inactive state to finish the events.

At the timings t3 and t4, the synchronization event and the conventional 3GPP SPEC event should be finished by the UE 110 without monitoring the C-RNTI Type 3 PDCCH CSS or USS.

At a timing t5, another conventional 3GPP SPEC event happens in the DRX active state.

With the scenario illustrated in FIG. 4, the DRX inactive reduces monitoring activities of the UE 110 during the PDCCH skipping duration to conserve power and extends the battery life.

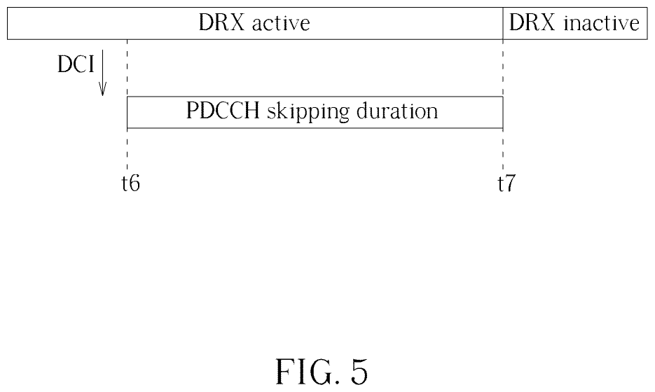

Please refer to FIG. 5, which is a schematic diagram of the PDCCH skipping scenario according to another embodiment of the present invention.

As shown in FIG. 5, the PDCCH skipping duration starts at a timing t6 and ends at a timing t7, and the DRX inactive starts at the timing t7. Since the UE 110 emulates the state akin to the simulated DRX inactive state during the PDCCH skipping duration, the DRX inactive equivalently starts earlier at the timing t6 in the scenario. Therefore, the power consumption is reduced and the power gain is increased.

Notably, those skilled in the art may properly design the method and the UE according to different system requirements. For example, different number of DRX inactive states during the PDCCH skipping may all be adjusted according to different system requirements, and not limited thereto.

In summary, the present invention provides a method and a user equipment to reduce monitoring activities of the UE and increase the power gain of the UE.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reducing power consumption, for a user equipment (UE) of a wireless communication network, comprising:
receiving a message indicating a commencement of a physical downlink control channel (PDCCH) skipping duration from a network node;
determining whether or not to enable a simulated discontinuous reception (DRX) inactive state during the PDCCH skipping duration according to at least one predefined condition predefined condition; and
entering the simulated DRX inactive state when the at least one predefined condition is met.

2. The method for reducing power consumption of claim 1, wherein the at least one predefined condition comprises that the UE is not required to monitor cell radio network identifier (C-RNTI) on Type 3 PDCCH Common Search Space (CSS).

3. The method for reducing power consumption of claim 1, wherein the at least one predefined condition comprises that the UE is not required to monitor cell radio network identifier (C-RNTI) on User Specific Search Space (USS).

4. The method for reducing power consumption of claim 1, wherein the simulated DRX inactive state reduces monitoring activities of the UE to conserve power.

5. The method for reducing power consumption of claim 1, wherein the PDCCH skipping duration is performed under a DRX active state.

6. The method for reducing power consumption of claim 1, wherein the UE exist the simulated DRX inactive state when a synchronization event is performed by the UE in the PDCCH skipping duration.

7. The method for reducing power consumption of claim 1, wherein a UE behavior of the UE in the simulated DRX inactive state is same with the UE in a DRX inactive state.

8. The method for reducing power consumption of claim 1, wherein the message is downlink control information (DCI).

9. The method for reducing power consumption of claim 1, wherein when the message further indicates a Search Space Set Group (SSSG) parameter and the at least one predefined condition is met, entering the simulated DRX inactive state for a PDCCH monitoring occasion gap.

10. The method for reducing power consumption of claim 9, wherein the PDCCH monitoring occasion gap is a duration between two adjacent PDCCH monitoring occasions in the SSSG parameters.

11. A User Equipment (UE) of a wireless communication network, comprising:
a wireless transceiver, configured to perform wireless transmission and reception to and from a service network; and
a controller, configured to receive a message indicating a commencement of a physical downlink control channel (PDCCH) skipping duration from a network node; to determine whether or not to enable a simulated discontinuous reception (DRX) inactive state during the PDCCH skipping duration according to at least one predefined condition; and to enter the simulated DRX inactive state when the at least one predefined condition is met.

12. The UE of a wireless communication network of claim 11, wherein the at least one predefined condition comprises that the UE is not required to monitor cell radio network identifier (C-RNTI) on Type 3 PDCCH Common Search Space (CSS).

13. The UE of a wireless communication network of claim 11, wherein the at least one predefined condition comprises that the UE is not required to monitor cell radio network identifier (C-RNTI) on User Specific Search Space (USS).

14. The UE of a wireless communication network of claim 11, wherein the simulated DRX inactive state reduces monitoring activities of the UE to conserve power.

15. The UE of a wireless communication network of claim 11, wherein the PDCCH skipping duration is performed under a DRX active state.

16. The UE of a wireless communication network of claim 11, wherein the UE exist the simulated DRX inactive state when a synchronization event is performed by the UE in the PDCCH skipping duration.

17. The UE of a wireless communication network of claim 11, wherein a UE behavior of the UE in the simulated DRX inactive state is same with the UE in a DRX inactive state.

18. The UE of a wireless communication network of claim 11, wherein the message is downlink control information (DCI).

19. The UE of a wireless communication network of claim 11, wherein when the message further indicates a Search Space Set Group (SSSG) parameter and the at least one predefined condition is met, entering the simulated DRX inactive state for a PDCCH monitoring occasion gap.

20. The UE of a wireless communication network of claim 19, wherein the PDCCH monitoring occasion gap is a duration between two adjacent PDCCH monitoring occasions in the SSSG parameters.
